(19) United States
(12) Patent Application Publication
(10) Pub. No.: US 2020/0167650 A1
(43) Pub. Date: May 28, 2020

(54) HINTED NEURAL NETWORK

(71) Applicant: Element AI Inc., Montreal (CA)

(72) Inventors: Joel LAMY-POIRIER, Montreal (CA); Anqi XU, Montreal (CA)

(21) Appl. No.: 16/691,831

(22) Filed: Nov. 22, 2019

Related U.S. Application Data
(60) Provisional application No. 62/770,954, filed on Nov. 23, 2018.

(51) Int. Cl. G06N 3/08; G06N 20/00; G06T 7/70

(52) U.S. Cl. CPC G06N 3/08; G06N 20/00; G06T 7/70; G06T 2207/10032; G06T 2207/20081; G06T 2207/30244; G06T 2207/20084

(57) ABSTRACT

Systems and methods for use with neural networks. A hint input is used in conjunction with a data input to assist in producing a more accurate output. The hint input may be derived from auxiliary data sources or it may be sampled from a universe of potential outputs. The hint input may also be cascaded across iterations such that the output of a previous iteration forms at least part of the hint input for a later iteration.

### RELATED APPLICATIONS

This application is a Non-Provisional Patent Application which claims the benefit of U.S. Provisional Patent Application No. 62/770,954 filed on Nov. 23, 2018.

### TECHNICAL FIELD

The present invention relates to the operation of neural networks. More specifically, the present invention relates to the use of a hint input to improve the output of a neural network.

### BACKGROUND

Neural network-based methods achieve excellent results in many tasks including: image classification, object detection, speech recognition, and image processing. Neural networks are composed of multiple layers of computational units with connections between various layers.

Neural networks are also commonly used to solve regression tasks. The primary goal of a regression task is to use one source of data as an input and, using that data, to correlate and predict a different kind of data as an output. Regression techniques may be used in many fields including computer vision. One problematic task in computer vision is that of camera localization—determining the position and orientation (i.e. the pose) of a camera from one or more images taken by that camera. This task can be formulated as supervised regression but, unfortunately, this approach has issues. For one thing, there is no guarantee of a suitable solution as the predicted pose could end up being the average of the various possible poses.

It should be clear that the ability to predict the position and orientation of a camera based on the images that the camera captures has many applications in augmented reality and mobile robotics. More specifically, camera localization is often used in conjunction with visual odometry and simultaneous localization and mapping systems by reinitializing the pose of the camera when camera tracking fails.

Various methods for camera localization have been developed as interest in this problem has increased. A survey of solutions for camera relocalization, which is synonymous to visual-based localization, image localization, etc., is provided in the literature. Similar methods have also been applied to the related task of visual place recognition, in which metric localization can be used as a means towards semantic landmark association.

An effective family of localization methods work by matching appearance-based image content with geometric structures from a 3-D environment model. Such models are typically built off-line using Structure from Motion (SfM) and visual SLAM tools. Given a query image, point features (e.g. SIFT) corresponding to salient visual landmarks are extracted and matched with the 3-D model, in order to triangulate the resulting pose. While these methods can produce extremely accurate pose estimates, building and maintaining their 3-D environment models is very costly in resources. As well, this structure-based approach tends to not generalize well at scale and under appearance changes.

In contrast to the above, PoseNet is an appearance-only approach for camera localization. The PoseNet approach uses a Convolutional Neural Network (CNN) and separate regressors for predicting position and orientation. While the original PoseNet's training loss used a hand-tuned β to balance the different scales for position and orientation, a follow-up work replaced β with weights that learned the homoscedastic uncertainties for both sources of errors.

A number of techniques have been developed to address fundamental limitations of PoseNet's appearance-only approach by adding temporal and geometric knowledge. MapNet incorporates geometry into the training loss by learning a Siamese PoseNet pair for localizing consecutive frames. The MapNet+ extension adds relative pose estimates from unlabeled video sequences and other sensors into the training loss, while MapNet+PGO further enforces global pose consistency over a sliding window of recent query frames. Laskar et al. also learned a Siamese CNN backbone to regress relative pose between image pairs, but then uses a memory-based approach for triangulating the query pose from visually similar training samples. Finally, VLocNet adds an auxiliary odometry network onto PoseNet to jointly regress per-frame absolute pose and consecutive-pair relative pose, while the follow-up VLocNet++ further learns semantic segmentation as an auxiliary task. By sharing CNN backbone weights at early layers, joint learning of absolute pose, relative pose, and auxiliary tasks have led to significantly improved predictions. In some cases, these techniques have led to results which even surpass the performance of 3-D structure-based localization.

In addition to the above, others have attempted to combine PoseNet with data augmentation and have met with mixed results. SPP-Net combined a 3-D structure approach with PoseNet by processing a sampled grid of SIFT features through a CNN backbone and pose prediction layers. While this architecture resulted only in comparable performance to PoseNet, some gains were achieved by training on extra poses, which were synthesized from a 3-D SIFT point-cloud model. More directly, Jia et al. showed improved accuracy by importing a dense SfM environment model into a graphics engine and then training PoseNet on densely-sampled synthesized scenes.

Based on the above, there is a need for systems and methods that improve upon the performance of the PoseNet approach. Preferably, such methods and systems are also applicable to tasks other than regression.

### SUMMARY

The present invention provides systems and methods for use with neural networks. A hint input is used in conjunction with a data input to assist in producing a more accurate output. The hint input may be derived from auxiliary data sources or it may be sampled from a universe of potential outputs. The hint input may also be cascaded across iterations such that the output of a previous iteration forms part of the hint input for a later iteration.

In a first aspect, the present invention provides a method for operating a neural network, the method comprising:

a) receiving input data;

b) receiving at least one hint input;

c) processing said input data and said at least one hint input together;

d) processing a result of step c) using said neural network;

e) receiving an output of said neural network;

wherein said at least one hint input causes said output to be closer to a projected desired result.

### BRIEF DESCRIPTION OF THE DRAWINGS

The present invention will now be described by reference to the following figures, in which identical reference numerals refer to identical elements and in which:

FIG. 1 is a block diagram of a system according to one aspect of the invention;

FIG. 2 is a diagram illustrating the data flow in a variant of the system shown in FIG. 1;

FIG. 3 is a diagram illustrating the data flow in another variant of the system shown in FIG. 1; and

FIG. 4 illustrates experimental results for training the various variants of the present invention.

### DETAILED DESCRIPTION

The present invention provides systems and methods for improving the output of a task performed by a neural network. The present invention can achieve results that equal or better the state-of-the-art in neural network regression tasks while using input data that does not require additional data sources to produce an output that tends toward a desired output. Rather than using more expensive methods of acquiring additional information from extra data sources to improve the output of a task, the input data for the present invention merely requires “hints” from known data sources.

Methods using hints allow the present invention to improve the output of a task performed by a neural network without relying on additional data sources. Additionally, methods using hints allows the present invention to account for large ambiguities in input data. For example, if the input data is an image, ambiguities may result from similar features, distorted features, or blurred features.

Hints refer to an input from known data sources and that may be indicative of a projected desired result. The hint input can include contents of the input data or it can include data that provides information relating to the input data that will result in an improved output. Improving the output refers to obtaining an output that is closer to or that tends toward a desired result. For example, in a camera localization task, the desired result is the correct position and orientation of the camera. For such a task, the hint could be a prior position and orientation of the camera or the hint could be details on a landmark observed in the input data.

It should be clear that the discussion that follows uses an implementation of the present invention that involves the “camera relocalization” task. For this task, the goal is to determine the position and orientation of a camera device given an acquired camera frame. Such ability to localize camera images is invaluable for diverse applications, for example replacing Global Positioning System (GPS) and Inertial Navigation System (INS), providing spatial reference for Augmented Reality experiences, and helping robots and vehicles self-localize. In these setups, often there are auxiliary data sources that can help with localization, such as GPS and other sensors, as well as temporal odometry priors.

The camera relocalization task can be formulated as supervised regression, however there are no general guarantees of smoothness or bijectivity concerning the image-pose mapping. One issue with the task is that an environment might contain visually-similar landmarks and this may cause images of the environment to have similar appearances and yet these similar appearances could map to drastically different poses. In this case a mode-averaged prediction would localize to somewhere between the similar landmarks, which generally would not be a useful result for the task.

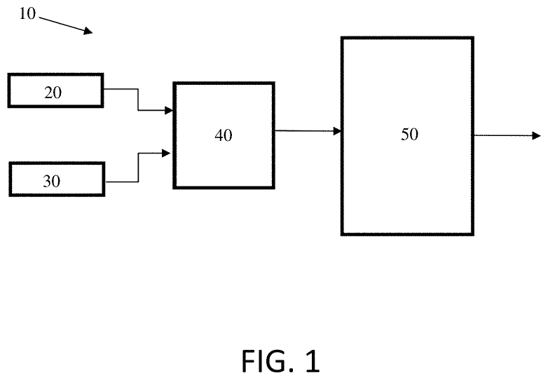

Referring now to FIG. 1, a block diagram showing a system according to one aspect of the invention is illustrated. The system 10 takes hint input 20 and input data 30 as input to an input module 40. The input module 40 performs any pre-processing of the inputs that is required. A person skilled in the art will appreciate that there are numerous ways to pre-process input data, including, but not limited to: compressing the inputs into a set of extracted features, combining multiple types of input data, scaling the data, and converting the inputs from one data type to another, such as converting analog data to digital data. After pre-processing, the hint input 20 and input data 30 are then processed together at processing module 50. The processing module 50 processes the data from input module 40 to produce an output. As noted above, the processing in the processing module 50 may include the use of a neural network.

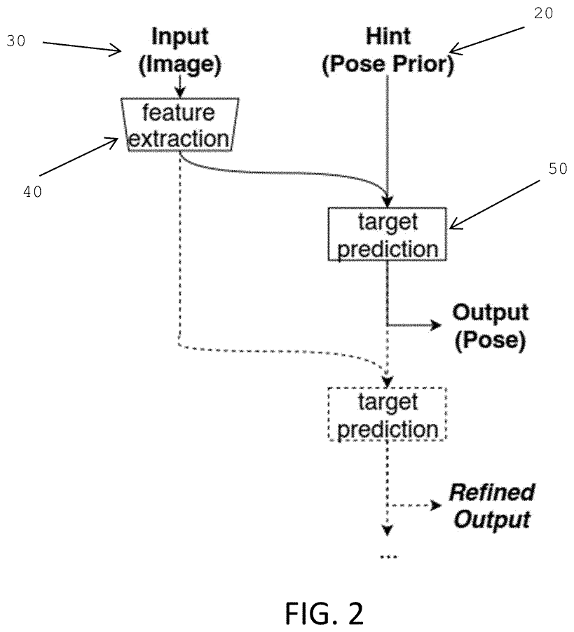

In some implementations, a system similar to that illustrated in FIG. 1 may be used in an iterative manner. For such a system where the processing module uses a neural network, the hint input may be cascaded such that the output of one iteration is the hint input to at least one successive iteration. The concept is that each iteration of produces a result that is progressively closer to a desired output. In tasks such as regression, multiple successive iterations allow for improved prediction accuracies in the output such that, even when an initial hint is far from a desired output, multiple iterations eventually produce a result that is close to the desired output. Referring to FIG. 2, the data flow in such an iterative system is illustrated. For the system in FIG. 2, the output from the processing module 50 is used as the hint input 20 for at least one subsequent iteration. In one implementation, each successive iteration uses the output of the immediately preceding iteration as its hint input. In other implementations, the output of one iteration may be used as the hint input for other iterations and not necessarily just for the immediately successive iteration. Thus, the output of iteration x may be used as the hint input for iteration x+1. Alternatively, the output of iteration x may be used as the hint input for iteration x+n where x and n are integers.

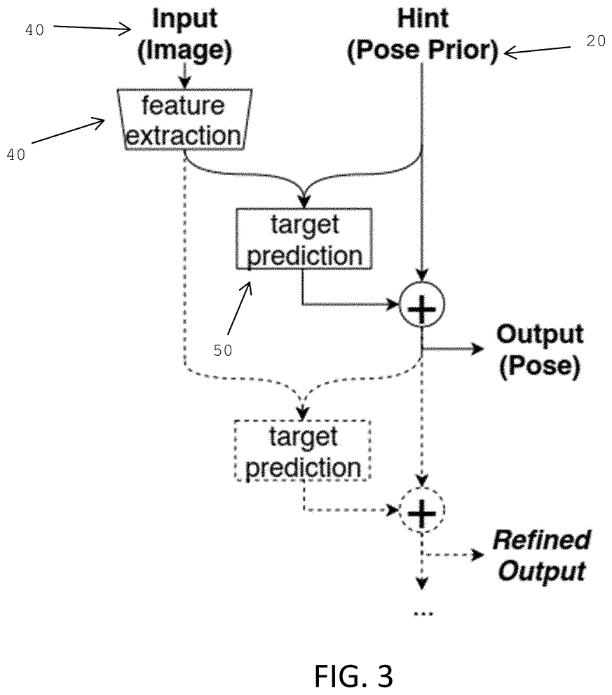

Conversely, in yet another implementation of a system that uses iterations, the initial hint input 20 may be used as part of the hint input for more than one successive iteration. In a specific implementation, at each iteration, the given hint (as input or from the output of a previous iteration) may be added to or combined with the output from the joint input-hint processing. For clarity, for this implementation, at each iteration, the joint input-hint prediction is combined with the unprocessed hint for that iteration. The data flow for such a system is schematically illustrated in FIG. 3. For this system, rather than simply using the output from the processing module 50 as the hint input 20, as is done in the data flow in FIG. 2, the original hint input 20 or a new hint can be used in each iteration. For regression tasks, the data flow shown in FIG. 3 transforms the regression task from absolute-value regression into residual regression. Residual networks as shown in FIG. 3 have been shown to optimize faster and to yield superior output data. One benefit of the system and data flow shown in FIG. 3 is that the output from this data flow does not have to be an absolute value. Rather, the output only needs to be a prediction of the desired value that can be refined in subsequent iterations. It should be clear that although FIG. 3 shows an addition of the hint input to the data input, other means of combining these two may be used. As examples, the hint input may be concatenated with the data input or the hint input may be added to the data input.

It should be clear that the hint used in the system of FIG. 3 may be pre-processed. As such, the input to the system can be pre-processed using a CNN (convolutional neural network) to result in an input embedding. Similarly, the hint can be pre-processed in isolation to result in a hint embedding/processed hint. The system in FIG. 3 can thus use the preprocessed hint rather than a raw, unprocessed hint.

The system and method of the present invention, especially when applied to the camera relocalization task, reformulates a statistical regression task into a different learning problem with the same inputs and outputs, albeit with an added “hint” at the input that provides an estimate for the output. While this reformulation works best when a prior exists, the present invention is useful even in the absence of informed priors or auxiliary information. The data flow illustrated in FIG. 2 uses the hint as a conditioning prior to resolve ambiguities in the input data. The data flow illustrated in FIG. 3 builds upon the system and method shown in FIG. 2 by converting the learning task from absolute-value into residual regression. One motivation and benefit of the present invention is its “mode seeking” behaviors. Another advantage of the present invention is that, since the hint and output have the same representation, this feed-forward model can be improved through iterative refinement, by recurrently feeding predictions as successive hints to refine accuracy as shown by the data flows illustrated in FIGS. 2 and 3.

In one aspect, the present invention provides a set of transformations for neural network regression models aimed at simplifying the target prediction task by providing hints or indications of the output values. While some domains offer natural sources of auxiliary information that can be used as informed hints, such as using GPS for camera relocalization tasks, the present invention can improve prediction accuracy over base models without relying on extra data sources at inference time through the use of uninformed hints. It should be clear that informed hints refer to auxiliary data that has been gathered from auxiliary data sources and which provides an indication of a potential or a possible output/outcome. As an example, for the camera relocalization task, an informed hint may be a known previous camera pose or it may be a GPS derived location of the camera. An uninformed hint, on the other hand, refers to data that indicates a possible universe of outcomes or outputs. As an example, for the camera relocalization task, an uninformed hint may be a sample from a normal distribution of locations within the estimated bounds of the environment.

When training a neural network that uses aspects of the present invention, informed hints can be obtained by applying noise (e.g. noise that follows a localized probability distribution, such as Gaussian noise) around the ground truth value of each data sample and then using the noisy ground truth value as the informed hint input to train the neural network. During inference however, it is assumed that no auxiliary information is available. Uninformed hints can be obtained by sampling from a uniform distribution within estimated bounds of the environment. While this may appear counterproductive, experiments demonstrate that uninformed hints, despite providing much coarser pose estimates than seen during training, help to improve localization accuracy for real-world datasets compared to the PoseNet base model.

Additionally, since the hint and output share the same representation, the predictions can be fed back to the network as subsequent hints recurrently as shown in the data flows of FIGS. 2 and 3. Such iterative refinement simplifies the regression task by allowing the model to successively improve prediction accuracies, even when the initial hint is very far from the target. Also, this process is computationally inexpensive, since the feature embedding, whose computation tends to make up the bulk of the workload, can be reused between iterations.

Contrary to recurrent neural networks that rely on recurrent training, the present invention applies recurrent hint connections only at inference time, after the neural network has been trained. One benefit of non-recurrent training is to reduce overfitting by preventing potentially harmful interactions between successive iterations. Additionally, the non-recurrently-trained network observes evenly-spread distributions of priors, in contrast to a series of correlated priors observed with an unrolled compute graph.

In one specific implementation, the scale of the Gaussian noise applied to the ground truth values may be tuned with care in order to attain optimal inference-time localization accuracy. As extreme cases of failures, if the training hints are too close to the ground truth, the neural network may choose to output the hint directly and to bypass the image-to-pose regression path. On the other hand, if hints are too far away, then the neural network may not be able to use them efficiently to help disambiguate challenging image-to-pose mapping instances.

In another specific implementation, the present invention was used in a camera relocalization task as set out above. For this implementation, the base model for solving camera relocalization tasks is derived from PoseNet, and specifically its “PoseNet2” variant with learned G² weights for homoscedastic uncertainties. This model's architecture is derived from the GoogLeNet (Inception v1) classifier, which is truncated after the final pooling layer. In place of the removed softmax, PoseNet2 attaches a pose prediction sub-network, which is composed of a single 2048-channel fully-connected hidden layer (with ReLU activation) acting on the feature space, followed by linear output layers for predicting 3-D Cartesian position x and 4-D quaternion orientation q.

For this implementation, this version of PoseNet2 was implemented using the TensorFlow-Slim library, and, in particular reused an existing GoogLeNet CNN backbone with pre-trained weights on the ImageNet dataset. This model maps 224×224 color images into a 1024-dimensional feature space. The TF-Slim implementation deviates from the original formulation by adding batch normalization after every convolutional layer. For simplicity, the auxiliary branches from the Inception v1 backbone were omitted. It should be clear that the present invention can also be used for terrestrial camera relocalization tasks. For such tasks and others, the images used with the present invention may be captured using mobile computing devices such as wearable devices, mobile phones, etc.

As can be seen from FIGS. 2 and 3, both systems that use iterations extend the architecture illustrated in FIG. 1 while using features of the PoseNet2 implementation. While the feature extractor of this specific implementation can be copied verbatim from PoseNet2's CNN backbone, the target prediction sub-network for the base model architecture (PoseNet2 implementation) would need to be modified in order to accept the concatenation of the feature vector (data input) and the hint vector (hint input) as input. Thus, this implementation of a neural network that accepts hinted inputs would contain three hidden layers (as opposed to PoseNet2's single 2048-channel pose prediction layer), with 1024, 2048, and 1024 channels respectively, to ensure sufficient mixing of the concatenated tensor.

Regarding pre-processing, for this implementation, the images were pre-processed by down-scaling and square-cropping to a resolution of 224×224, and then normalizing pixel intensities to range from −1.0 to 1.0. All target quaternions were also normalized and sign-disambiguated by restricting them to a single hyper-hemisphere. Since each orientation can be represented ambiguously by two sign-differing quaternion vectors, it can be crucial for both training and evaluating regressors to consistently map all quaternions onto a single hyper-hemisphere. This is achieved by unit-normalizing their magnitudes, and also sign-normalizing the first non-zero component.

Furthermore, contrary to other existing PoseNet-style systems, in this implementation the models were trained on PCA-whitened representations of both position and orientation. In addition to normalizing across mismatched dimensions, whitening removes the need to manually specify initial scales for regression-layer weights and for hints. Having initial pose estimates matching the scales of each environment may be crucial during training. Predicted poses are de-whitened prior to evaluating the training loss and at query time.

To assess the above implementation of the present invention on camera relocalization tasks, the outdoor Cambridge Landmarks dataset and indoor 7-Scenes dataset were used. These terrestrial datasets are comprised of images that were taken using hand-held cameras, targeting nearby landmarks with predominantly forward-facing orientations. In addition, the above implementation was also assessed for aerial-view localization, where the goal is to localize high-altitude downward-facing camera frames acquired by aerial drones. Results for these aerial-view localization assessments are provided further below.

Prior to using the above noted implementation, all models were optimized with Adam using default parameters and a learning rate of 1×10⁻⁴, for 50k (7-Scenes) and 100k (Cambridge) iterations, with a batch size of 64. During training, hint inputs were sampled from Gaussian noise around ground truth with uncorrelated deviations of 0.3 along each PCA-whitened axis. During inference, hint inputs were initialized with a unit-scale normal distribution and fed through the neural network until convergence.

The results of the assessment of one implementation of the present invention are shown in Table 1. For clarity, the “Hinted Embedding” in the various Tables refers an implementation to where the data flow is as shown in FIG. 2 while the “Hinted Residual” in the various Tables refers to an implementation where the data flow is as shown in FIG. 3.

Referring to the results in Table 1, the implementation of the present invention attains slightly worse localization accuracy compared to previous attempts. This can be attributed to minor discrepancies in the architecture, pre-processing, and training regime. To isolate the effects of the architecture from those of the experimental setup, the custom implementation of PoseNet2 noted above was used as the comparative baseline.

In contrast to the results achieved in the above noted previous attempts, the implementation where the data flow is as shown in FIG. 3 boasts superior localization accuracies for most scenes, both in position and especially in orientation. On the other hand, the implementation where the data flow is as shown in FIG. 2 converges to pose predictions that are no better than PoseNet2 for most scenes. Furthermore, the test-set errors for certain scenes are slightly elevated during late training for PoseNet2, thus reflecting a sign of overfitting; this was not observed for either architecture that involved iterations.

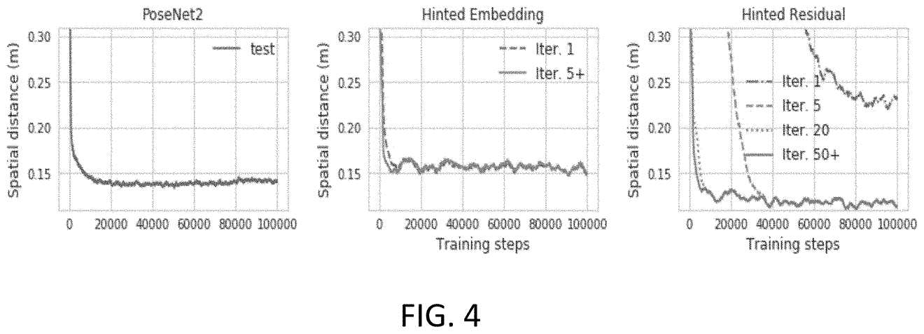

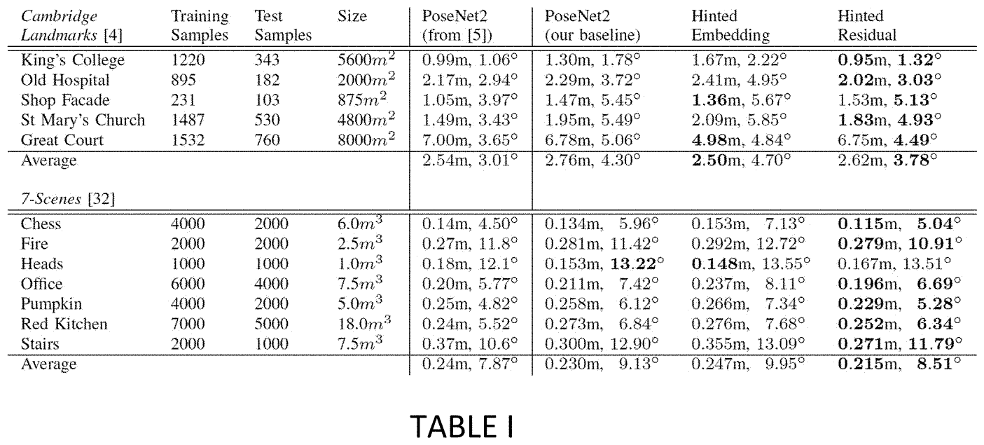

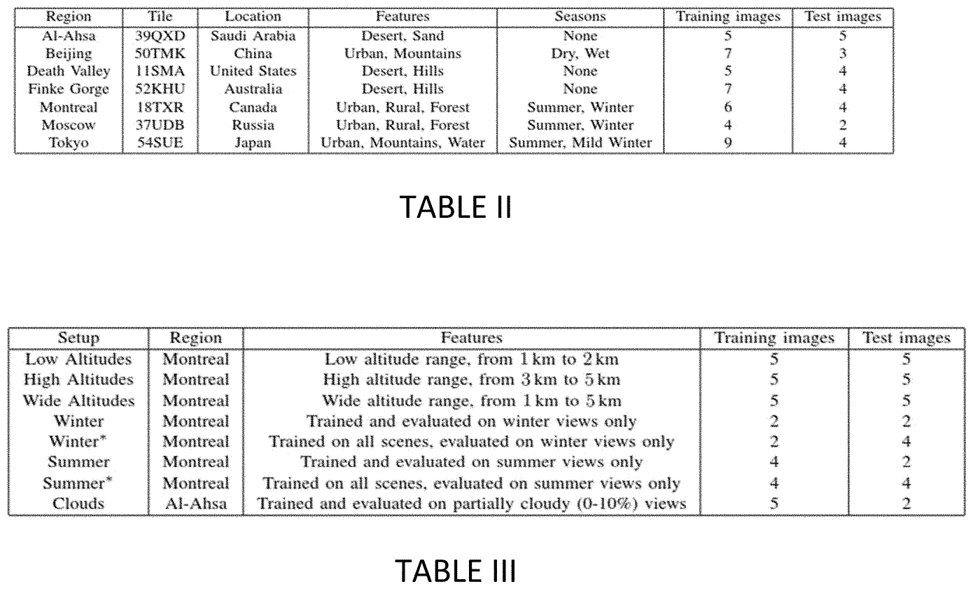

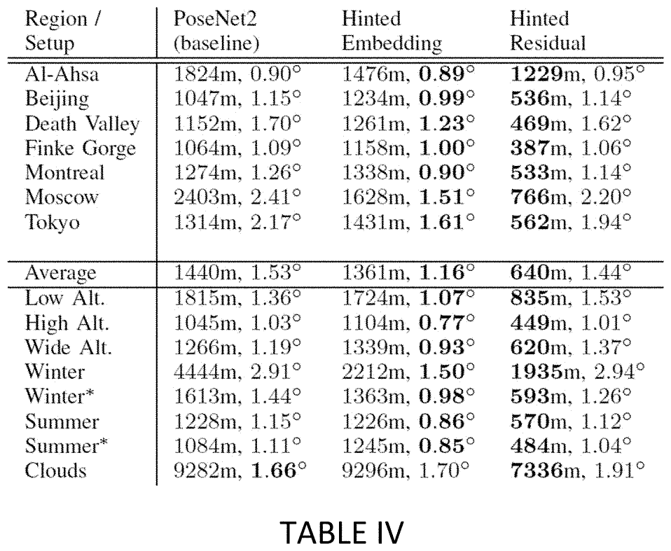

Additionally, as seen in FIG. 4, while PoseNet2 models train faster, the neural networks that used a data flow as shown in FIG. 3 were able to leverage iterative refinement to make more accurate predictions. In contrast, after an initial learning phase, the neural networks that used a data flow as shown in FIG. 2 converged numerically without benefiting from recurrent connections. The results from FIG. 4 suggest that systems which use the iterative refinement process provides the best results. It should be clear that the “Chess scene” referred to in FIG. 4 refers to one of the seven subsets within the training data set “7-Scenes”. This data set is often used in the field to measure performance.

To further assess the capabilities of the present invention, a number of localization experiments on aerial views were conducted with the present invention. For these experiments, more visual ambiguities were expected. Such aerial-view localization would be useful in diverse GPS-denied scenarios, including underwater and extra-terrestrial planetary surfaces.

For this assessment, models were trained and evaluated on synthesized downward-facing images from aerial drones. These images were extracted from large-scale satellite imagery. This setup is motivated both by data availability and the possibility to deliberately factor out effects of sparse sampling and limited dataset size by using online data generators.

For this assessment, the satellite scenes used were based on data from the Sentinel-2 Earth observation mission by the European Space Agency (ESA). All imagery is publicly and freely available on ESA's Copernicus Open Access Hub. Seven regions with various degrees of self-similarity and seasonal variations were selected and these are enumerated along with their main features in Table II. Each region maps to a specific Sentinel-2 mission tile, and covers a square area of 12,000 km², with a pixel resolution of ten m. For each region, up to thirteen non-cloudy sample images were selected, depending on availability. The dataset was then split into between four to nine training sets and between two to five test tiles. While it was an aim to split datasets randomly, the datasets were set up to also ensure that each season is represented in both the training and test sets.

Variations of the above setups were experimented on to study effects of altitude ranges, cross-seasonal variations, and the presence of clouds, as enumerated in Table III.

In terms of pre-processing, tile images were converted from 16-bits to 8-bits (per channel) according to pixel intensity ranges. The data generator synthesized orthogonally-projected camera frames by uniformly sampling at different positions, orientations, and altitudes, with a horizontal field-of-view of 100°. Unless otherwise specified, altitudes are sampled between two km and three km.

It should be clear that, for this assessment, model architectures and training regimes are nearly identical to those from the previous assessment with a number of specific differences. One difference is that, since each pose only has a single planar yaw angle, a 2-D cosine-sine heading vector was regressed instead of a quaternion. As well, altitude was regressed separately from lateral coordinates given their large differences in scale, using an independently-learned uncertainty factor Ŝ_{z}. Moreover, given the unlimited number of image-pose samples that are generated on-the-fly, models can benefit from longer training, which was set at 500k iterations. It should also be clear the 3D angles may also be used.

As a final distinction, for these experiments the training hint noise scale was set to 0.2 for the spatial dimensions and 0.5 for the angular dimensions.

In terms of results for the aerial view localization, Table IV shows the localization performances for the diverse setups. Similar to the terrestrial experiments, the system with a data flow as shown in FIG. 3 demonstrated overall greater accuracy in predicting positions as compared to baseline models. However, this system did not localize orientation as well. On the other hand, the system with the data flow as shown in FIG. 2 interestingly excelled at predicting angular poses. This suggests that the use of a hinted input is especially useful to localize scenes with high degrees of visual ambiguity.

Focusing on the altitude experiments, it was found that all models performed better at high altitudes due to wider camera swaths. It was also observed that hint inputs are more useful at lower altitudes given pronounced visual ambiguities, and that the neural networks are capable of learning location-pertinent visual attributes within a wide range of altitudes. As for cross-seasonal experiments, it was found that all the neural networks, regardless of architecture, were able to learn seasonal variations. More importantly, it was found that these neural networks can also leverage data from one season to improve predictions within another view. As an example, including summer scenes in the Montreal dataset drastically improved prediction accuracy in the harder winter scenes, even though landmark textures were blanketed by snow in the latter scenes.

It should be clear that the various aspects of the present invention may be implemented as software modules in an overall software system. As such, the present invention may thus take the form of computer executable instructions that, when executed, implements various software modules with predefined functions.

The embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A method for operating a neural network, the method comprising:
a) receiving input data;
b) receiving a hint input;
c) processing said input data and said hint input together;
d) processing a result of step c) using said neural network;
e) receiving an output of said neural network; and
wherein said hint input causes said output to be closer to a projected desired result.

2. The method according to claim 1, wherein said hint input causes said output to be closer to a projected desired result over multiple iterations of said method.

3. The method according to claim 1, wherein said method is iterated and a target prediction for one iteration is combined with said input data to result in a result for a subsequent iteration.

4. The method according to claim 1, wherein said at least one hint input is related to said projected desired result or is selected from a group of potential outputs.

5. The method according to claim 1, wherein said at least one hint input is selected from a group of potential outputs.

6. The method according to claim 1, wherein said at least one hint input is randomly generated.

7. The method according to claim 1, wherein said at least one hint input is randomly selected from a group of potential outputs.

8. The method according to claim 1, wherein said method is iterated and subsequent iterations use said input data and said hint input with results of previous iterations to produce said output that is closer to said projected desired result.

9. The method according to claim 1, wherein said output is closer to said projected desired result when compared to an output produced using only said input data.

10. The method according to claim 1, wherein said method is iterated and at least one hint input for one iteration of said method is derived from an output of a previous iteration of said method.

11. The method according to claim 1, wherein said method is iterated and at least one hint input for one iteration of said method is derived from an output of an immediately previous iteration of said method.

12. The method according to claim 1, wherein said method is applied to at least one aerial-view localization task.

13. The method according to claim 1, wherein said method is applied to at least one of: a camera relocalization task and a terrestrial camera relocalization task.

14. The method according to claim 13, wherein said projected desired result is a pose of a camera used to capture images and said images comprise said input data.

15. The method according to claim 13, wherein said aerial-view localization is used on images for areas where GPS is unavailable.

16. The method according to claim 15, wherein said images are underwater images.

17. The method according to claim 11, wherein said task is for localizing high-altitude downward-facing images.

18. The method according to claim 17, wherein said images are acquired by aerial drones.

19. The method according to claim 1, wherein said input data comprises images.

20. The method according to claim 19, wherein said images are captured using mobile computing devices.
